(19) United States
(12) Patent Application Publication
(10) Pub. No.: US 2026/0259379 A1
(43) Pub. Date: Sep. 3, 2026

(54) MULTI-FIBER OPTICAL CONNECTOR

(71) Applicant: Fujikura Ltd., Tokyo (JP)

(72) Inventor: Ryoichi Mitobe, Chiba (JP)

(73) Assignee: Fujikura Ltd., Tokyo (JP)

(21) Appl. No.: 19/489,264

(22) PCT Filed: May 24, 2024
(86) PCT No.: PCT/JP2024/019279

§ 371 Date: Dec. 2, 2025

(30) Foreign Application Priority Data
May 31, 2023 (JP) 2023-089677

(51) Int. Cl. G02B 6/38

(52) U.S. Cl. CPC G02B 6/3858

(57) ABSTRACT

A multi-fiber optical connector includes: a ferrule having 13 or more fiber holes in a row, and a connection end surface on which the fiber holes are open; optical fibers configured to be inserted into the fiber holes; a spring configured to generate a biasing force against the ferrule and into which the optical fibers are inserted; and a spring push configured to receive a reaction force of the biasing force. The spring has: a first inner diameter in a first direction of the row, and a second inner diameter in a second direction orthogonal to the first direction and a longitudinal direction of the fiber holes. The first inner diameter is larger than the second inner diameter. The first inner diameter is larger than an outside width of the row of the fiber holes.

### TECHNICAL FIELD

The present invention relates to a multi-fiber optical connector.

Priority is claimed on Japanese Patent Application No. 2023-089677, filed May 31, 2023, the content of which is incorporated herein by reference.

### BACKGROUND

Patent Document 1 discloses a multi-fiber optical connector including a plurality of optical fibers. This multi-fiber optical connector includes a ferrule into which a total of 24 optical fibers can be inserted. Specifically, fiber holes for inserting the optical fibers are formed in two rows in the ferrule, and each row includes 12 fiber holes. Further, an elliptical spring for biasing the ferrule is disposed behind the ferrule. The optical fibers are inserted into the spring.

### PATENT LITERATURE

Patent Document 1: Japanese Unexamined Patent Application, First Publication No. 2017-102390

In such a multi-fiber optical connector, it is required to further increase the number of connectable optical fibers. For example, in the multi-fiber optical connector disclosed in Patent Document 1, in a case where the number of fiber holes arranged in one row is increased, the optical fibers inserted into the spring may come into contact with the spring. For example, the optical fibers can be bent in order to prevent the optical fibers from coming into contact with the spring, but, in such a case, it is necessary to make a bending radius of the optical fibers larger than an allowable bending radius. In order to increase the bending radius, it is necessary to increase a length of an internal space of the multi-fiber optical connector as compared with the related art. As a result, there is an issue that the multi-fiber optical connector becomes large in size.

### SUMMARY

One or more embodiments of the present invention increase the number of connectable optical fibers while avoiding an increase in size of a multi-fiber optical connector.

A first aspect of the present invention relates to a multi-fiber optical connector including: a ferrule including 13 or more fiber holes arranged in one row and a connection end surface on which the fiber holes are open; a plurality of optical fibers configured to be inserted into the fiber holes; a spring configured to generate a biasing force against the ferrule and into which the plurality of optical fibers are inserted; and a spring push configured to receive a reaction force of the biasing force, in which the spring includes a first inner diameter in a first direction in which the fiber holes are arranged and a second inner diameter in a second direction orthogonal to the first direction and a longitudinal direction of the fiber holes, the first inner diameter is larger than the second inner diameter, and the first inner diameter is larger than an outer dimension in which the fiber holes are arranged in the one row.

A second aspect of the present invention relates to the multi-fiber optical connector according to the first aspect, further including: a housing in which a part of the ferrule and the spring are accommodated and that includes an engagement portion that engages with the spring push, in which the housing has an inner wall that guides an outer periphery of the spring.

A third aspect of the present invention relates to the multi-fiber optical connector according to the second aspect, in which the inner wall of the housing has a curved surface that is in contact with the spring.

A fourth aspect of the present invention relates to the multi-fiber optical connector according to any one of the first to third aspects, in which the spring push includes a pair of engagement claws that engages with a pair of engagement portions of the housing, and the pair of engagement claws has an inner wall that guides the outer periphery of the spring.

A fifth aspect of the present invention relates to the multi-fiber optical connector according to the fourth aspect, in which the inner wall of the engagement claw has a curved surface that is in contact with the spring.

A sixth aspect of the present invention relates to the multi-fiber optical connector according to any one of the first to fifth aspects, in which the inner wall of the housing guides the outer periphery of the spring from an outer side in the second direction, and the inner wall of the engagement claw guides the outer periphery of the spring from an outer side in the first direction.

### Advantageous Effects of Invention

According to the above-described aspects of the present invention, it is possible to increase the number of connectable optical fibers while avoiding an increase in size of the multi-fiber optical connector.

### BRIEF DESCRIPTION OF THE DRAWINGS

FIG. 1 A perspective view of a multi-fiber optical connector according to one or more embodiments.

FIG. 2 An exploded perspective view of the multi-fiber optical connector of FIG. 1.

FIG. 3 A sectional view taken along line III-III of FIG. 1.

FIG. 4 A sectional view taken along line IV-IV of FIG. 1.

FIG. 5A A schematic view showing a connection of a pair of connectors according to a comparative example by an adapter.

FIG. 5B A schematic view showing a connection of a pair of multi-fiber optical connectors according to one or more embodiments by an adapter.

### DETAILED DESCRIPTION

Hereinafter, a multi-fiber optical connector according to one or more embodiments will be described with reference to the accompanying drawings.

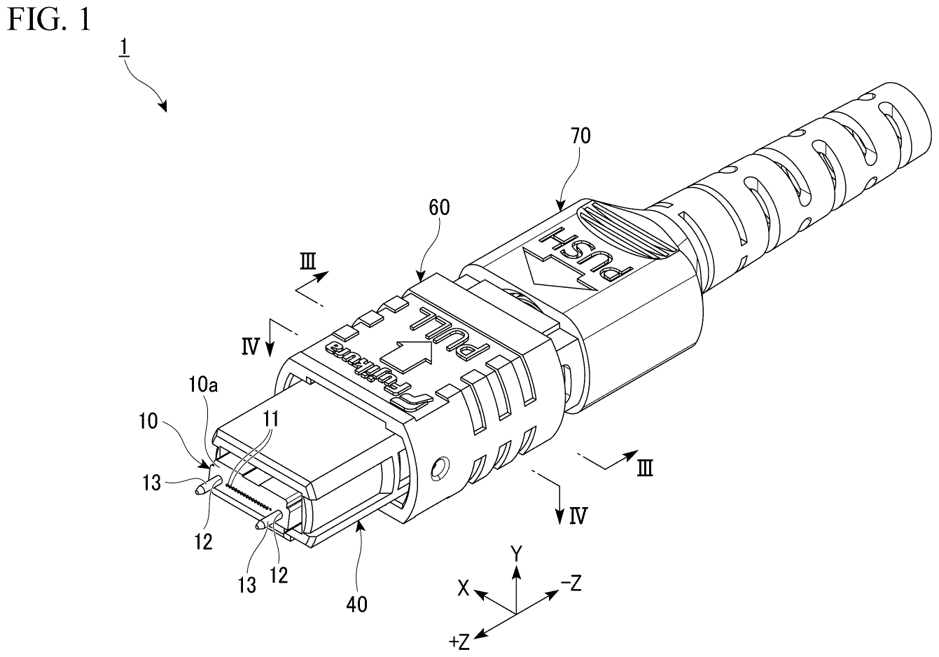

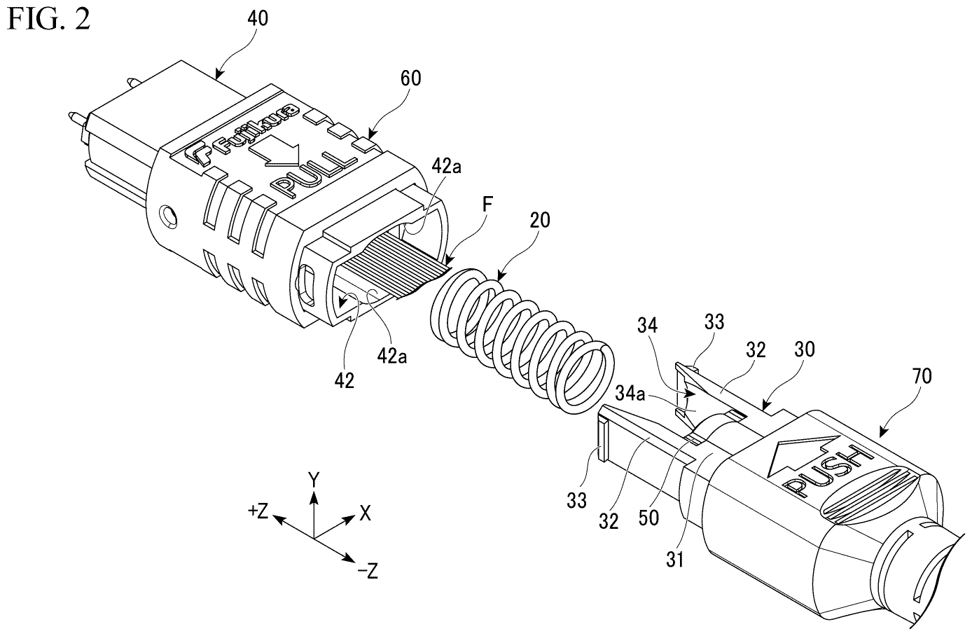

As shown in FIGS. 1 and 2, a multi-fiber optical connector 1 includes a ferrule 10, a spring 20, a spring push 30, a housing 40, a movable member (push-pull) 60, a boot 70, and a plurality of optical fibers F. A plurality of fiber holes 11 arranged in one row are formed in the ferrule 10. In one or more embodiments, 16 fiber holes 11 are arranged in one row. The embodiments may be used for a multi-fiber optical connector in which the number of fiber holes 11 arranged in one row is 13 or more. However, the number of fiber holes 11 may be 12 or less or 17 or more.

The ferrule 10 has a connection end surface 10a. The fiber holes 11 are open on the connection end surface 10a. An optical fiber F is inserted into each of the fiber holes 11. The optical fibers F are exposed on the connection end surface 10a. A connection end surface of the other optical connector abuts on the connection end surface 10a, so that the multi-fiber optical connector 1 can be optically connected to the other optical connector. However, the optical fibers F need not be inserted into some of the fiber holes 11 of the ferrule 10. That is, the number of optical fibers F may be less than the number of fiber holes 11.

### (Direction Definition)

A direction in which the plurality of fiber holes 11 extend will be referred to as a longitudinal direction Z. A connection end surface 10a side (+Z side) in the longitudinal direction Z will be referred to as a distal end side. The opposite side thereof (the −Z side) will be referred to as a base end side. A direction in which the fiber holes 11 are arranged in one row will be referred to as a first direction X. The first direction X is orthogonal to the longitudinal direction Z. A direction orthogonal to both the first direction X and the longitudinal direction Z will be referred to as a second direction Y.

Two positioning holes 12 are formed in the ferrule 10. The two positioning holes 12 are disposed to interpose the plurality of fiber holes 11 in the first direction X. The multi-fiber optical connector 1 according to one or more embodiments is a male connector, and a positioning pin 13 is inserted into the positioning hole 12. However, the multi-fiber optical connector 1 may be a female connector. That is, the multi-fiber optical connector 1 need not include the positioning pin 13.

The optical fibers F are inserted into the fiber holes 11 and extend from the ferrule 10 to the base end side (in a direction opposite to the connection end surface 10a). In FIG. 2, some of the optical fibers F are not shown, but the plurality of optical fibers F are inserted into the spring 20. In addition, the plurality of optical fibers F are also inserted into the spring push 30 and into the boot 70.

As shown in FIG. 2, the spring push 30 has a support portion 31 and a pair of engagement claws 32. The pair of engagement claws 32 extends from the support portion 31 toward the distal end side. The pair of engagement claws 32 are disposed with a spacing therebetween in the first direction X. An engagement protrusion 33 that protrudes outward in the first direction X is formed at a distal end of each of the pair of engagement claws 32. The support portion 31 is a portion that supports the spring 20 from the base end side. In one or more embodiments, an adjustment member 50 is disposed between the support portion 31 and the spring 20. An elastic force of the spring 20 is transmitted to the support portion 31 via the adjustment member 50. In addition, the engagement protrusions 33 of the pair of engagement claws 32 are engaged with an engagement portion 41 (described later) of the housing 40. With this configuration, the spring push 30 receives a reaction force (a force toward-Z side) of a biasing force generated by the spring 20 and supports the reaction force.

A part of the ferrule 10 and the spring 20 are accommodated in the housing 40. A part of the ferrule 10 protrudes from the housing 40 toward the distal end side. The ferrule 10 is movable to the base end side against the biasing force of the spring 20. Specifically, in a case where the multi-fiber optical connector 1 is connected to the other connector, the ferrule 10 is pushed to a base end side by a ferrule of the other connector. As a result, the ferrule 10 moves to the base end side with respect to the housing 40.

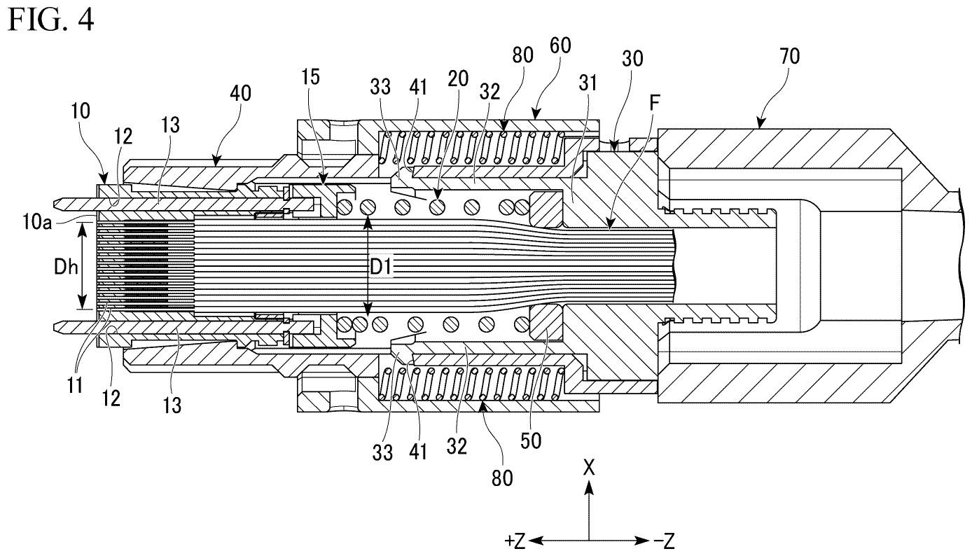

The housing 40 is a substantially quadrangular tubular shape. However, the shape of the housing 40 may be changed in accordance with the shape of the ferrule 10 or the like. As shown in FIG. 4, the engagement portions 41 are formed at both end portions of the housing 40 in the first direction X. The engagement portion 41 is a hole that penetrates the housing 40 in the first direction X. However, the shape of the engagement portion 41 may be changed as long as the engagement portion 41 can be engaged with the engagement claw 32. In one or more embodiments, the engagement protrusion 33 of the spring push 30 enters the inside of the engagement portion 41. In this way, the engagement claws 32 and the engagement portions 41 are engaged with each other, and thus the movement of the spring push 30 to the base end side with respect to the housing 40 beyond a predetermined position is restricted.

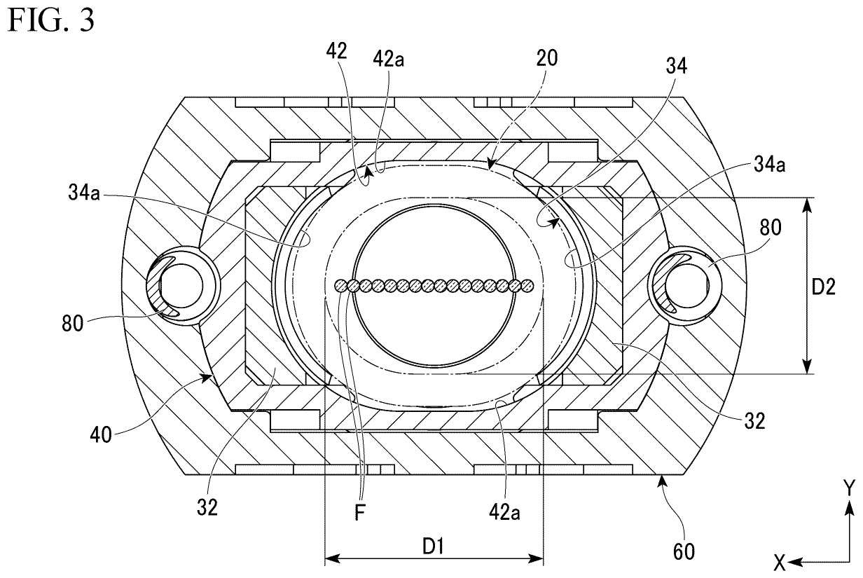

The spring 20 has a function of biasing the ferrule 10 to the distal end side. As shown in FIG. 3, the spring 20 according to one or more embodiments has an elliptical shape when viewed in the longitudinal direction Z. In FIG. 3, a range in which the spring 20 is present when viewed in the longitudinal direction Z is indicated by a one-dot chain line. An inner diameter of the spring 20 in the first direction X will be referred to as a “first inner diameter D1”. An inner diameter of the spring 20 in the second direction Y will be referred to as a “second inner diameter D2”. The first inner diameter D1 is larger than the second inner diameter D2. In addition, the shape of the spring 20 is not limited to an elliptical shape. The shape of the spring 20 may be formed by, for example, a pair of linear portions and a curved portion that connects end portions of the pair of linear portions, such as a track of an athletic field. As long as the first inner diameter D1 is larger than the second inner diameter D2, the shape of the spring 20 may be changed.

As shown in FIG. 4, a pin clamp 15 is disposed between the ferrule 10 and the spring 20. In addition, the adjustment member 50 is disposed between the spring 20 and the spring push 30. The spring 20 is compressed between the pin clamp 15 and the adjustment member 50. As a result, the spring 20 generates the biasing force toward the distal end side. The biasing force of the spring 20 is transmitted to the ferrule 10 via the pin clamp 15. The pin clamp 15 also has a function of holding the positioning pin 13. In addition, the pin clamp 15 and the adjustment member 50 may not be provided. That is, the spring 20 may be in contact with the ferrule 10 and the spring push 30.

The movable member 60 is disposed to surround the housing 40 from the outside. As shown in FIG. 4, a pair of second biasing members 80 are disposed in the movable member 60. The second biasing members 80 are disposed between the housing 40 and the movable member 60 and bias the movable member 60 toward the distal end side (+Z). Although a detailed description will be omitted, the movable member 60 is a portion that is operated when the multi-fiber optical connector 1 is pulled out from an adapter A or the like described later.

Here, as shown in FIGS. 2 and 3, a pair of curved surfaces 42a (housing side curved surfaces) are formed on an inner wall (housing inner wall) 42 of the housing 40. Each of the pair of curved surfaces 42a is recessed outward in the second direction Y. A pair of curved surfaces 34a (spring push side curved surfaces) are formed on the inner wall 34 of the spring push 30. Each of the pair of curved surfaces 34a is recessed outward in the first direction X. The “inner wall (housing inner wall) 42 of the housing 40” is a portion of the housing 40 that faces the spring 20. The “inner wall (engagement claw inner wall described later) 34 of the spring push 30” is a portion of the spring push 30 that faces the spring 20. The pair of curved surfaces 34a of the spring push 30 are formed on the pair of engagement claws 32, respectively.

As shown in FIG. 3, the pair of curved surfaces 42a of the housing 40 are disposed to interpose the spring 20 in the second direction Y. The pair of curved surfaces 34a of the spring push 30 are disposed to interpose the spring 20 in the first direction X. An outer periphery of the spring 20 is guided by the curved surfaces 34a and 42a. More specifically, in a case where any force is applied to the spring 20 in the second direction Y, the spring 20 abuts on the curved surface 42a of the housing 40, so that the spring 20 is prevented from buckling in the second direction Y.

In addition, in a case where any force is applied to the spring 20 in the first direction X, the spring 20 abuts on the curved surface 34a of the spring push 30, so that the spring 20 is prevented from buckling in the first direction X. That is, a force applied in a direction other than the longitudinal direction Z in which the spring 20 expands and contracts is suppressed by the spring 20 that abuts on the curved surface 42a and the curved surface 34a. With this configuration, the spring 20 is prevented from buckling, and an appropriate biasing force can be applied to the ferrule 10.

In the first direction X, the pair of curved surfaces 42a of the housing 40 may have a similar outer shape to the spring 20, and in the second direction Y, the curved surface 34a of the spring push 30 may have a similar outer shape to the spring 20.

Hereinafter, an effect obtained by the multi-fiber optical connector 1 configured as described above will be described.

As shown in FIG. 4, an outer dimension (i.e., outside width) of the fiber holes 11 arranged in one row on the connection end surface 10a is denoted by reference sign Dh. The “outer dimension Dh” is a dimension of a region in which the fiber holes 11 are present on the connection end surface 10a, in the first direction X. In one or more embodiments, a length (dimension) of the first inner diameter D1 of the spring 20 is larger than the outer dimension Dh of the fiber holes 11 arranged in one row. Therefore, even in a state where the plurality of optical fibers F extending from the ferrule 10 toward the base end side extend linearly in the longitudinal direction Z, it is possible to prevent the optical fibers F from coming into contact with the spring 20. Accordingly, damage to the optical fibers F and the like caused by the optical fibers F coming into contact with the spring 20 can be suppressed.

In addition, as shown in FIG. 3, the length (dimension) of the first inner diameter D1 of the spring 20 is larger than a length (dimension) of the second inner diameter D2. Stated another way, the spring 20 is not circular. When the spring 20 is circular, the length of the second inner diameter D2 in FIG. 3 is the same as the length of the first inner diameter D1. In this case, the, size of the housing 40 that accommodates the spring 20 in the second direction Y is insufficient. That is, it is necessary to increase the dimension of the housing 40 in the second direction Y, which leads to the increase in size of the multi-fiber optical connector 1. Accordingly, D1 and D2 are set such that D1>D2. That is, it is possible to avoid the increase in size of the housing 40 while satisfying the relationship of Dh<D1.

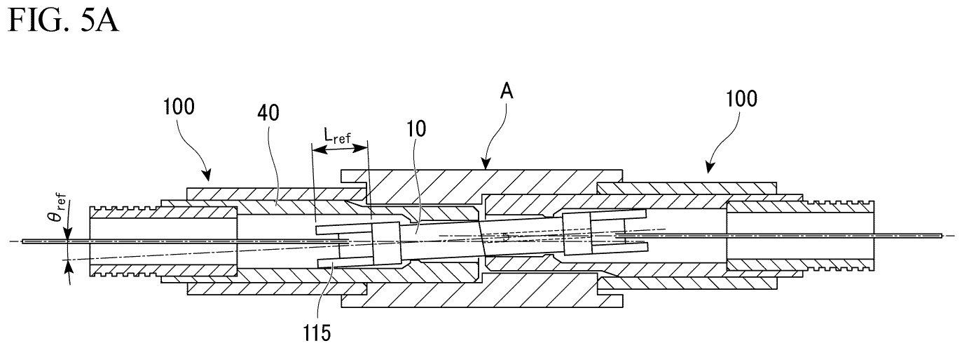

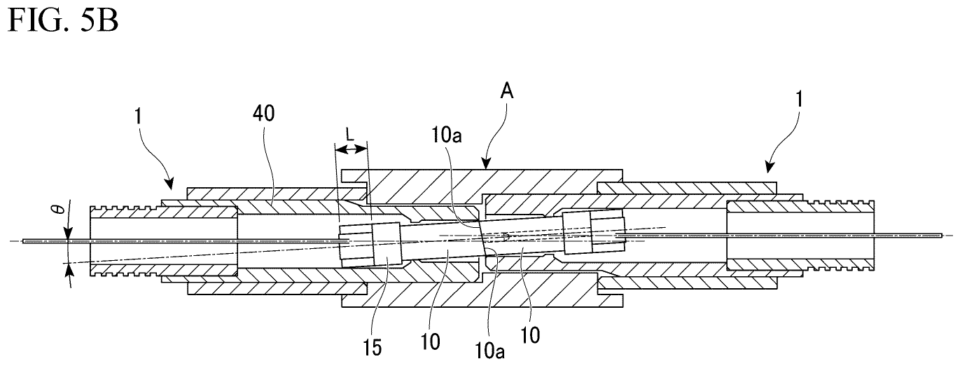

FIG. 5A is a schematic view showing a case where two connectors 100 according to a comparative example are connected to each other by the adapter A. FIG. 5B is a schematic view showing a case where two multi-fiber optical connectors 1 according to one or more embodiments are connected to each other by the adapter A. In the multi-fiber optical connector 1 according to one or more embodiments, the spring 20 that biases the ferrule 10 has an elliptical shape (see FIG. 3). On the other hand, in the connector 100 according to the comparative example, a spring (not shown) that biases the ferrule 10 is circular. The basic structures of the multi-fiber optical connector 1 and the connector 100, such as the shape of the ferrule 10, the number of optical fibers F, and the biasing force of the spring, are the same as each other. However, the multi-fiber optical connector 1 and the connector 100 have different structures in part due to the difference in shape of the spring. FIGS. 5A and 5B are views in which the two connectors 100 according to the comparative example and the two multi-fiber optical connectors 1 according to one or more embodiments are viewed in the direction shown in FIG. 4. Therefore, as in FIG. 4, the longitudinal direction of FIGS. 5A and 5B is a Z direction, and a direction orthogonal to the Z direction is an X direction.

The length (dimension) of the inner diameter of the circular spring according to the comparative example is less than the length (dimension) of the first inner diameter D1 of the spring 20 in one or more embodiments and is larger than the length (dimension) of the second inner diameter D2.

In the connector 100 according to the comparative example, a length Lref of the pin clamp 115 in the longitudinal direction is larger than a length L of the pin clamp 15 according to one or more embodiments. The reason for this is that the inner diameters of the springs are different in the direction (first direction X) in which the optical fibers F are arranged in one row between the connector 100 and the multi-fiber optical connector 1.

More specifically, the length (dimension) of the inner diameter of the spring of the connector 100 in the first direction X is less than the length (dimension) of the first inner diameter D1 of the spring 20 of the multi-fiber optical connector 1. The optical fibers extending from the pin clamp 115 toward the base end side need to be bent at a bending radius larger than an allowable bending radius and then inserted into the spring. Therefore, in the connector 100 according to the comparative example, the optical fibers are gently bent inside the pin clamp 115. In order to gently bend the optical fibers, the length Lref is a value larger than the length L.

In FIG. 5A, θref represents a maximum value of an angle at which the ferrule 10 and the pin clamp 115 can be inclined inside the housing 40 in the connector 100 of the comparative example. In FIGS. 5B, θ represents a maximum value of an angle at which the ferrule 10 and the pin clamp 15 can be inclined inside the housing in the multi-fiber optical connector 1 according to one or more embodiments. As can be seen from FIGS. 5A and 5B, there is a difference in the magnitudes of θ and θref due to the difference between the lengths L and Lref of the pin clamps 15 and 115.

More specifically, since Lref>L, θref<θ is satisfied. That is, in the multi-fiber optical connector 1, the ferrule 10 and the pin clamp 15 can be largely inclined inside the housing 40 as compared with the connector 100 of the comparative example. In this way, by increasing the space for the ferrule 10 and the like to be inclined inside the housing 40, the stability of the connection between the multi-fiber optical connectors 1 using the adapter A can be further increased.

As described above, the multi-fiber optical connector 1 according to one or more embodiments includes the 13 or more fiber holes 11 arranged in one row, the ferrule 10 having the connection end surface 10a on which the fiber holes 11 are open, the plurality of optical fibers F that are inserted into the fiber holes 11 and extend from the ferrule 10 toward the opposite side (−Z side) of the connection end surface 10a, the spring 20 that generates the biasing force against the ferrule 10 and into which the plurality of optical fibers F are inserted, and the spring push 30 that receives the reaction force of the biasing force. In the spring 20, the length (dimension) of the first inner diameter D1 in the first direction X in which the fiber holes 11 are arranged is larger than the length (dimension) of the second inner diameter D2 in the second direction Y orthogonal to both the first direction X and the longitudinal direction Z of the fiber holes 11, and the length (dimension) of the first inner diameter D1 is larger than the outer dimension Dh of the plurality of fiber holes 11 arranged in one row.

With this configuration, even in a state where the plurality of optical fibers F extending from the ferrule 10 extend in a straight line in the longitudinal direction Z, it is possible to prevent the optical fibers F from coming into contact with the spring 20. Therefore, damage to the optical fibers F and the like caused by the optical fibers F coming into contact with the spring 20 can be suppressed. Further, since the optical fibers F need not be bent toward the inside of the spring 20, it is not necessary to increase the dimension of the spring push 30 in the longitudinal direction. Accordingly, it is possible to increase the number of connectable optical fibers F while avoiding the increase in size of the multi-fiber optical connector 1.

In addition, the multi-fiber optical connector 1 further includes the housing 40 in which a part of the ferrule 10 and the spring 20 are accommodated and that has the engagement portion 41 that engages with the spring push 30. The housing 40 has the inner wall 42 that guides the outer periphery of the spring 20. With this configuration, even in a case where the spring 20 is non-circular, the spring 20 can be prevented from buckling.

In addition, the inner wall 42 of the housing 40 has the curved surface 42a that is in contact with the spring 20. By guiding the spring 20 with the curved surface 42a, it is possible to more reliably prevent the spring 20 from buckling.

In addition, the spring push 30 has the pair of engagement claws 32 that engage with the engagement portion 41 of the housing 40, and the pair of engagement claws 32 has the inner wall (engagement claw inner wall) 34 that guides the outer periphery of the spring 20. With this configuration, even in a case where the spring 20 is non-circular, the spring 20 can be prevented from buckling.

In addition, the inner wall (engagement claw inner wall) 34 of the engagement claw 32 has the curved surface 34a that is in contact with the spring 20. By guiding the spring 20 with the curved surface 34a, it is possible to more reliably prevent the spring 20 from buckling.

In addition, the inner wall (housing inner wall) 42 of the housing 40 guides the outer periphery of the spring 20 from an outer side in the second direction Y, and the inner wall 34 of the engagement claw 32 guides the outer periphery of the spring 20 from an outer side in the first direction X. As described above, since the outer periphery of the spring 20 is guided from both the first direction X and the second direction Y, buckling, falling, and the like of the spring 20 can be more reliably prevented.

In addition, the technical scope of the present invention is not limited to the above-described embodiments, and various modifications can be made without departing from the scope of the present invention.

For example, in the above-described embodiments, the inner wall 42 of the housing and the inner wall 34 of the engagement claw 32 have the curved surfaces 34a and 42a. However, even when the curved surfaces 34a and 42a are not provided, it is possible to guide the outer periphery of the spring 20. Therefore, the curved surfaces 34a and 42a are not essential components. Only one of the pair of curved surfaces 34a and the pair of curved surfaces 42a may be provided.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Multi-fiber optical connector
10 Ferrule
10a Connection end surface
11 Fiber hole
12 Positioning hole
20 Spring
30 Spring push
32 Engagement claw
34 Inner wall of engagement claw (engagement claw inner wall)
34a Curved surface
40 Housing
41 Engagement portion
42 Inner wall of housing (housing inner wall)
42a Curved surface
D1 First inner diameter
D2 Second inner diameter
Dh Outer dimension
F Optical fiber
X First direction
Y Second direction
Z Longitudinal direction

1. A multi-fiber optical connector comprising:
a ferrule having:
13 or more fiber holes in a row; and
a connection end surface on which the fiber holes are open;
optical fibers configured to be inserted into the fiber holes;
a spring configured to generate a biasing force against the ferrule and into which the optical fibers are inserted; and
a spring push configured to receive a reaction force of the biasing force, wherein the spring has:
a first inner diameter in a first direction of the row, and
a second inner diameter in a second direction orthogonal to the first direction and a longitudinal direction of the fiber holes,
the first inner diameter is larger than the second inner diameter, and
the first inner diameter is larger than an outside width of the row of the fiber holes.

2. The multi-fiber optical connector according to claim 1, further comprising:
a housing in which a part of the ferrule and the spring are accommodated and that comprises an engagement portion that engages with the spring push, wherein
the housing comprises a housing inner wall that guides an outer periphery of the spring.

3. The multi-fiber optical connector according to claim 2, wherein the housing inner wall has a curved surface in contact with the spring.

4. The multi-fiber optical connector according to claim 2, wherein
the housing comprises a pair of engagement portions,
the spring push comprises a pair of engagement claws that engages with the pair of engagement portions, and
each of the pair of engagement claws comprises an engagement claw inner wall that guides the outer periphery of the spring.

5. The multi-fiber optical connector according to claim 4, wherein the engagement claw inner wall has a curved surface in contact with the spring.

6. The multi-fiber optical connector according to claim 4, wherein
the housing inner wall guides the outer periphery of the spring in the second direction, and
the engagement claw inner wall guides the outer periphery of the spring in the first direction.
